(19) United States
(12) Patent Application Publication
(10) Pub. No.: US 2006/0064413 A1
(43) Pub. Date: Mar. 23, 2006

(54) Data retrieval method and device

(76) Inventors: Yuichi Uzawa, Yokohama (JP); Yasuhiro Ooba, Kawasaki (JP)

Correspondence Address: KATTEN MUCHIN ROSENMAN LLP, 575 MADISON AVENUE, NEW YORK, NY, 10022-2585, US

(21) Appl. No.: 11/266,551

(22) Filed: Nov. 3, 2005

Related U.S. Application Data
(63) Continuation of application No. PCT/JP03/09740, filed on Jul. 31, 2003.

(51) Int. Cl. G06F 17/30

(52) U.S. Cl. 707/3

(57) ABSTRACT

In a method and device for retrieving data matching a retrieval key from a database, entries having all of unmasked bits in all of retrieved fields matched with data bits of retrieval keys corresponding to the unmasked bits are determined to be an interim retrieval result from among entries divided into a plurality of fields and stored in a database; a longest prefix length for each of the retrieved fields is obtained from among prefix lengths of the retrieved fields of the interim retrieval result; and an entry in the interim retrieval result having the longest prefix length in one of the retrieved fields whose priority is the highest is determined to be a retrieval result.

### BACKGROUND OF THE INVENTION

1. Field of the Invention

The present invention relates to a data retrieval method and device, and in particular to a data retrieval method and device retrieving data matching a retrieval key from a database.

2. Description of the Related Art

A router or a switch that forms a repeating point of a network is required to perform route selection processing, namely routing, corresponding to a destination of a packet (e.g. IP datagram) flowing within the network.

For example, a router 101 shown in Fig.6 forms a repeating point of a network, and network lines 102-105 are connected to the router 101. Also, servers 130, 140, and 150 are respectively connected to the ends of the network lines 103-105.

As shown in FIG. 6, each information of a destination IP address 111 and a source IP address 112 belonging to the layer 3 as well as a destination port number 113 and source port number 114 belonging to the layer 4 is included in a header of a packet 110 received by the router 101 through the network line 102.

A destination network to which the packet 110 should be transmitted can be identified from the destination IP address 111. Also, a sender of the packet 110 can be identified from the source IP address 112, so that it is also made possible to grasp the contents (such as line capacity) of an contract related to a network usage entered into between the identified sender and a network provider. Moreover, it is made possible to determine types of application and the like from the destination port number 113 and the source port number 114.

Therefore, the router 101 performs the routing of the layer 3 or the layer 4 based on the information so as to output the packet 110 to the appropriate network lines 103, 104, and 105.

For example, as for the line capacities (bandwidths) of the network lines 103 and 104, if the network line 103 has a large capacity and the network line 104 has a small capacity as respectively shown by the thickness of the solid line, it is made possible to perform the routing corresponding to the contents of the contract, related to the line capacity, with the sender of the packet 110.

Also, by associating the servers 130, 140, and 150 with each of the applications, it is also made possible to perform load balancing with the routing of the layer 3.

By appropriately performing the routing in the router 101, it is made possible to configure a flexible network.

Generally, the above-mentioned routing is realized by a software and hardware data retrieval processing for a destination. Specifically, a content addressable/associative memory (CAM) device has been mainly used as a data retrieval device for performing a high-speed/large-capacity routing.

It is to be noted that the CAM device has been used not only for a router performing the routing in the layer 3 or the layer 4 as the above-mentioned router 101 but also for switching by a MAC address like a layer 2 switch (not shown).

As an example of routing using the CAM device, IP address retrieval processing will now be described referring to FIG. 7.

FIG. 7 shows an arrangement of portions related to the routing in e.g. the router 101 of FIG. 6.

A CAM device 200 has a database 203 where an entry group for retrieval is stored. A network processor 210 is a processor specialized in the network processing. Also, a context-RAM (or associated-RAM) 220 is a memory where processing contents and the like corresponding to the entries of the CAM device 200 are stored, and is usually composed of memory devices such as SRAM and DRAM.

The CAM device 200, the network processor 210 and the context-RAM 200 are connected to one another with an input interface 211 and output buses 201 and 221.

In operation, the network processor 210 extracts header information from the received packet 110 and inputs an IP address, a port number or the like to be retrieved as a retrieval key 212 to the CAM device 200 through the input interface 211. In the database 203 within the CAM device 200, the IP address information preliminarily inputted by a network manager is held as the entry group, so that the CAM device 200 compares the retrieval key 212 with each of the entries of the database 203.

It is to be noted that the comparison operation by the CAM device 200 is simultaneously performed for each bit in each of the entries. As a result of the retrieval, if appropriate entries exist or are hit, a physical address (address [2] in the example shown in FIG. 7) of the “most” appropriate entry among them is provided to the context RAM 220 through the output bus 201 as a hit address 202.

The context RAM 220, for example, provides the network processor 210 with data of processing contents to be handled or an output port (destination of distribution), corresponding to the address [2] obtained as the hit address 202 of FIG. 7, as a retrieval result 222 through the output bus 221.

The network processor 210 processes the packet 110 or performs the retrieval again according to the retrieval result 222.

The prior art IP address retrieval processing in the above-mentioned CAM device 200 will now be described in more detail referring to FIG. 8.

FIG. 8 shows in more detail the portions related to the IP address retrieval processing in the CAM device 200 of FIG. 7. Therefore, for convenience'sake of the description, only the top four entries #1-#4 are shown among the entry group preliminarily inputted by the network manager in the database 203 of FIG. 7. Also, match lines 321-324 are respectively provided to the entries #1-#4 and are respectively connected to a priority encoder 330.

Each of the entries #1-#4 is a pair of an IP address and a subnet mask held in the database 203. “A1”, “A2”, “A3”, and “A4”as IP addresses are respectively shown in the upper sections of the entries #1-#4 of FIG. 8, while the respective subnet masks are shown in the lower sections with consecutive bits of “1” and “0”. In this case, the consecutive bits of “1” show a prefix portion and the consecutive bits of “0” show a masked portion.

The entries #1-#4 are arranged in descending order of the length of the prefix portion (bit “1”) of the subnet mask, i.e. the prefix length, as shown in FIG. 8. Also, [1]-[4] shown on the right sides of the entries #1-#4 show the respective physical addresses.

A less significant bit nearer to the right side of the IP address indicates an address nearer to the end of the network. Similar to an address of a map, it can be said that a retrieval result matching more to a less significant bit indicating a more specific content is more appropriate. Namely, as a retrieval result of an IP address, an address with the longest prefix length is the most appropriate. Such a retrieval result is called a longest prefix match. This is the reason why the entries are stored by arranging in accordance with the prefix length.

In operation of the CAM device 200, e.g. an IP address “A-KEY” is inputted from the network processor 210 and the like as the retrieval key 212. The CAM device 200 performs the comparison of the bits simultaneously for all of the entries. However, the comparison is not performed for the bits whose subnet mask is “0” (don't care condition).

If any of the compared bits is found “mismatched”, a signal indicating the mismatch is outputted to the match lines 321-324, so that the entry is identified as a mismatched entry. In the example of FIG. 8, mismatch signals 331 and 333 are respectively outputted to the match lines 321 and 323, so that the entries #1 and #3 are identified as the mismatched entries.

If all of the compared bits are found “matched”, the entry is identified as a matched entry, or a hit, like the entries #2 and #4.

When a plurality of hits are thus found, the priority encoder 330 outputs the entry whose prefix length is longer, that is the physical address [2] of the entry #2 as the hit address 202.

Thus, when the data bits of the retrieval key 212 and the data bits of the entries #1-#4 are compared, a CAM device performing the mask processing by the mask bits handles data of ternary values, so that it is called a ternary CAM device. On the other hand, a CAM device that performs only the comparison between the data bits of the retrieval key 212 and the data bits of the entries #1-#4 but does not perform the mask processing handles data of binary values, so that it is called a binary CAM device.

FIGS. 9A and 9B respectively show the function of a ternary CAM cell 600 corresponding to a single bit within a ternary CAM device and a truth table 610 of the retrieval result.

In FIG. 9A, the ternary CAM cell 600 holds a data bit 601 and a mask bit 602, and further has a comparison processor 603 which compares an inputted retrieval key 607 and the data bit 601 and a mask processor 604 which provides mask processing corresponding to the mask bit 602 from the comparison result outputted by the comparison processor 603.

A single entry of the database is composed of a plurality of ternary CAM cells 600 connected to a common match line 606.

In operation, the ternary CAM cell 600 outputs a result after providing mask processing by the mask processor 604 to the result of a comparison between the retrieval key 607 and the data bit 601 by the comparison processor 603 as a final retrieval result 605 to the match line 606.

Namely, the comparison processor 603 outputs “0” if the values of the retrieval key 607 and the data bit 601 are different, while otherwise outputting “1”. The mask processor 604 outputs the output of the comparison processor 603 unchanged as the retrieval result 605 when the value of the mask bit 602 is “1”, while compulsorily outputting “1”as the retrieval result 605 regardless of the output of the comparison processor 603 when the value of the mask bit 602 is “0”. FIG. 9B shows such a retrieval result in the form of a truth table.

It is to be noted that the logic may be inversed as long as the operation is identical.

For a function of holding the data bit 601 and the mask bit 602, for example, a flip-flop, a capacitor and a high dielectric film or magnetic film having a hysteresis are used.

If the above-mentioned CAM device 200 shown in FIGS. 7 and 8 is a ternary CAM device, the entries #1-#4 are composed of ternary CAM cells 600 corresponding to the number of bits of the entries. In this case, the match lines 321-324 correspond to the match line 606.

In the above-mentioned FIG. 8, the entries #1-#4 are shown as if only the IP addresses are held therein since it has been described by taking an example of retrieving only a specific item, namely the IP address. However, in the actual database 203 within the CAM device 200, as shown in FIG. 10A, data divided into a plurality of fields such as fields F1-F5 are stored in the entries #1-#4.

Namely, in the field F1 of the entries #1-#4, “SA1”-“SA4” as the respective source IP addresses are stored. Likewise, in the field F2, “DA1C”-“DA4” as the respective destination IP addresses are stored. Moreover, in the field F3, “SP1”-“SP4” as the respective source port numbers are stored, and in the field F4, “DP1”-“DP4” as the destination port numbers are stored.

Also, in the field F5, externally notified management information such as a tag indicating validity/invalidity of the entry as other information is stored.

It is to be noted that the fields F1 and F2 are shown to have upper and lower sections for the entries #1-#4. Since a subnet mask is usually applied to the fields F1 and F2, the respective prefix portions 431, 432 and the masked portions 441, 442 are shown in the lower section. Since subnet mask is usually unapplied to the fields F3-F5, they are shown in one section.

FIG. 10B shows a global mask pattern 450 used in case of designating only a specific field to be retrieved among the fields F1-F5 of FIG. 10A.

By using such a global mask pattern 450, in the example shown in FIG. 10B, the masked portions 451 and 453 are excluded from being retrieved so that only the field F2 indicating the destination IP address corresponding to the retrieved portion 452 is retrieved.

There is a conventionally proposed CAM device in which content-addressable memory array is composed of a plurality of fields, whereby a retrieved field is instructed so that retrieved data is applied to the instructed field and mask signals are provided to other fields, thereby performing the retrieval (see e.g. patent document 1).

Also, there is one that has stored therein routing information expressed by a combination of an IP address and a prefix length together with separate information of the prefix length (see e.g. patent document 2), or one that enables setting of an order of priority for a data selection externally and arbitrarily (see e.g. patent document 3).

Moreover, there is one that enables data retrieval with low electric power consumption and has a function of a memory width expansion with a higher integration (see e.g. patent document 4), or a variable width CAM device for retrieving variable width data (see e.g. patent document 5).

<Patent Document 1>

Japanese Patent Application Laid-open No.58-200494 (Claims, FIG. 1)

<Patent Document 2 >

Japanese Patent Application Laid-open No.2002-305539 (Abstract, FIG. 1)

<Patent Document 3>

Japanese Patent Application Laid-open No.11-102589 (Abstract, FIG. 1)

<Patent Document 4>

Japanese Patent Application Laid-open No.5-189978 (Abstract, FIG. 1)

<Patent Document 5>

Japanese Patent Application Laid-open No.2001-160292 (Abstract, FIG. 2A)

In the situation where the retrieval using the CAM device can be performed only with the width of several tens of bits, for example, it has been required to repeat the CAM retrieval a plurality of times in order to perform processing such as flow identification. While in recent years, many CAM devices support retrieval of multiple bit-widths exceeding several hundreds of bits. Taking an example of flow identification by the IPv4, it is made possible to retrieve a total of equal to or more than 96 bits at once as a single entry of a destination IP address (32 bits), a source IP address (32 bits), a destination port number (16 bits) and a source port number (16 bits).

However in the prior art mentioned above, when a plurality of entries are hit, the final retrieval result outputted by the priority encoder 330 depends on the storing order of the entries.

In order to obtain a different final retrieval result, it is required to change the storing order of the entries. However, this requires the rewriting of the database 203. In order to perform such maintenance of the database 203, it requires stopping the routing of the router 101, thereby increasing a network down time.

Therefore, in order to realize a constant operation of the network, the storing order of the entries cannot be easily changed.

On the other hand, with the expansion of use of a Virtual Private Network (VPN) in recent years, a flexible response for each of the customers has become important in the network operation. For example, at the time of a network failure, it is desired to prioritize an entry whose original storing order is low when it is required to prioritize a line of a specific customer.

Also, it is desired to prioritize an entry whose original storing order is low in case of performing an appropriate load balancing so as not to concentrate a load on an operating server or the like.

### SUMMARY OF THE INVENTION

It is accordingly an object of the present invention to provide a data retrieval method and device retrieving data that match a retrieval key from a database from which a retrieval result based on a desired priority (degree) can be obtained without being restricted by a storing order of the entries in.

In order to achieve the above-mentioned object, a data retrieval method according to the present invention comprises: a first step of determining, from among entries divided into a plurality of fields and stored in a database, entries having all of unmasked bits in all of retrieved fields matched with data bits of retrieval keys corresponding to the unmasked bits to be an interim retrieval result; a second step of obtaining a longest prefix length for each of the retrieved fields from among prefix lengths of the retrieved fields of the interim retrieval result; and a third step of determining an entry in the interim retrieval result having the longest prefix length in one of the retrieved fields whose priority is the highest to be a retrieval result.

The principle of the present invention will now be described referring to FIG. 1, which schematically shows a match/mismatch state for each of the entries #1-#5 stored in the database when a retrieval key (not shown) for a plurality of retrieved fields F1 and F2 is inputted.

In white background portions within each of the fields F1 and F2 surrounded by dotted lines or solid lines for each of the entries #1-#5, a numeric value shown as “/24”, for example, indicates the number of bits indicating a prefix length (length of the prefix portion without a subnet mask). Also, a shaded portion adjacent to the white background portion indicates a masked portion (a portion with a subnet mask).

Namely, it is shown that the prefix length of the field F1 of the entry #1 in FIG. 1 is 24 bits, and the prefix length of the field F2 is 22 bits. Likewise, the prefix lengths of the field F1 of the entries #2-#5 are 24 bits, 20 bits, 17 bits, and 12 bits, respectively while the prefix lengths of the field F2 are 17 bits, 17 bits, 22 bits, and 16 bits, respectively.

Also, the entries #1, #2, and #5 shown by the dotted lines are determined to be “mismatch” since at least one bit of the prefix portion does not match the data bit of the corresponding retrieval key.

On the other hand, the entries #3 and #4 shown by the solid lines have all bits (unmasked bits) of the prefix portion “matched” with the data bits of the corresponding retrieval key, thereby assuming an interim retrieval result, or being extracted.

With respect to the prior art retrieval method of a content-addressable memory, the retrieval result is outputted by regarding the storing order of the entries #1-#5 as the priority order, so that the entry #3 that is stored in a higher order among the entries #3 and #4 extracted as mentioned above is outputted as the retrieval result.

Different from such a prior art example, in the present invention, the longest prefix lengths in the fields F1 and F2 are obtained from the prefix lengths of each of the retrieved fields F1 and F2 stored in the prefix length register for the entries #3 and #4 extracted as mentioned above.

Namely, in FIG. 1, the longest prefix length for the field F1 is 20 bits obtained in the entry #3 and the longest prefix length for the field F2 is 22 bits obtained in the entry #4. Moreover in the present invention, the entry having the longest prefix length in one of the retrieved fields whose priority is the highest is made the final retrieval result.

Therefore, if one of the retrieved fields whose priority is the highest is the field F2, it is made possible to make the entry #4 stored in a lower level the final retrieval result among the entries #3 and #4 extracted as mentioned above.

Thus, by appropriately setting the priority, it is made possible to obtain a retrieval result based on a desired priority without being restricted by the storing order of the entries #1-#5 as in the prior art example.

The above-mentioned highest priority retrieved field may comprise a longest retrieved field in the longest prefix lengths obtained at the second step.

Namely, when the longest prefix length is used as an index for the above-mentioned priority, one of the retrieved fields whose priority is the highest is the retrieved field that is the longest in the longest prefix lengths obtained at the second step.

In the case of FIG. 1, 22 bits assuming the longest prefix length of the field F2 is longer than 20 bits assuming the longest prefix length of the field F1, so that one of the retrieved fields whose priority is the highest is the field F2 and the entry #4 having the longest prefix length (22 bits) in this field F2 is outputted as the retrieval result.

Thus, it becomes possible to obtain a more appropriate retrieval result regardless of the storing order of the entries.

Also, a priority may be set in each of the fields before retrieval is started.

Namely, in case of setting the above-mentioned priority to the fields before retrieval is started, for example, by setting the priority of the field F2 in FIG. 1 higher than that of the field F1, one of the retrieved fields whose priority is the highest is the field F2, so that the entry #4 having the longest prefix length (22 bits) in this field F2 is outputted as the retrieval result.

Thus, it becomes possible to obtain a retrieval result based on a priority set in each of the fields before the retrieval is started regardless of the storing order of the entries.

The priority in this case may be changed every time retrieval is made.

Namely, by making the above-mentioned priority changeable every time the retrieval is made without fixedly setting the priority, it is made possible to obtain a retrieval result based on a desired priority more flexibly.

Also, a field having a predetermined value set therein as the priority may be excluded from the retrieved fields.

Namely, by prescribing a predetermined value for excluding the field from retrieval, it is made possible to make a field in which a predetermined value is set as a priority to be excluded from the retrieval. This enables the above-mentioned priority to be used as a criterion for deciding whether or not the field is retrieved in addition to the determination of the final retrieval result.

Also, in order to achieve the above-mentioned object, a data retrieval device according to the present invention comprises: a database storing entries divided into a plurality of fields; a prefix length holding portion holding a prefix length per field of the entries; a computing portion determining entries having all of unmasked bits in all of retrieved fields matched with data bits of retrieval keys corresponding to the unmasked bits to be an interim retrieval result, obtaining a longest prefix length for each of the retrieved fields from among prefix lengths of the retrieved fields of the interim retrieval result, and determining an entry in the interim retrieval result having the longest prefix length in one of the retrieved fields whose priority is the highest to be a retrieval result.

The above-mentioned highest priority retrieved field may comprise a longest retrieved field in the longest prefix lengths obtained by the computing portion.

Also, a priority may be set in each of the fields before retrieval is started and this priority may be changeable every time retrieval is made.

Moreover, a field having a predetermined value set therein as the priority may be excluded from the retrieved fields.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle of a data retrieval method and device according to the present invention;

FIG. 2 is a block diagram showing an entry state example common to embodiments (1) and (2) of a data retrieval method and device according to the present invention;

FIG. 3 is a block diagram showing an embodiment (1) of a data retrieval method and device according to the present invention;

FIG. 4 is a block diagram showing an embodiment (2) of a data retrieval method and device according to the present invention;

FIG. 5 is a block diagram showing a modification of an embodiment (2) of a data retrieval method and device according to the present invention;

FIG. 6 is a block diagram illustrating an outline of a general routing;

FIG. 7 is a block diagram showing an arrangement of portions related to the routing within a router 101 in FIG. 6;

FIG. 8 is a block diagram showing a detailed arrangement of a CAM device 200 in FIG. 7;

FIGS. 9A and 9B are diagrams showing an arrangement of a ternary CAM cell used in a general CAM device and a truth table of retrieval result; and

FIGS. 10A and 10B are block diagrams showing an entry arrangement example within a general CAM device and a global mask pattern.

### DESCRIPTION OF THE EMBODIMENTS

Two types of embodiments, an embodiment (1) in a case where the longest prefix lengths are compared with one another for each of the fields, and an embodiment (2) in a case where a priority for each of the fields is preset will now be described referring to the present invention.

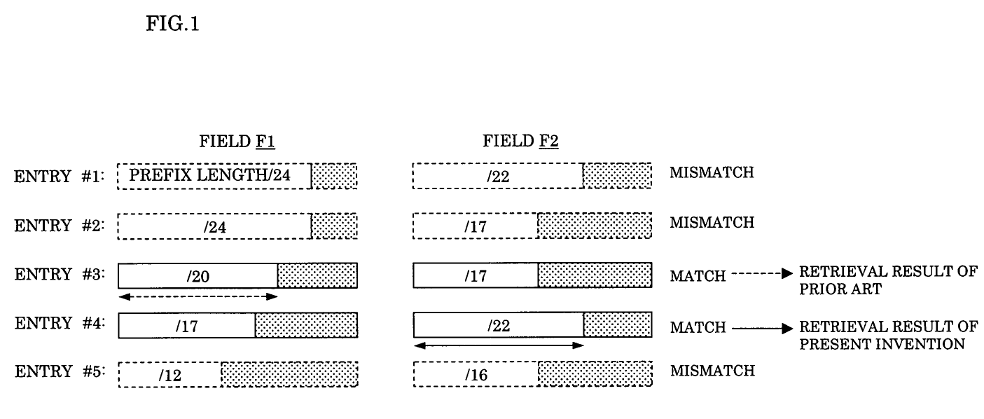

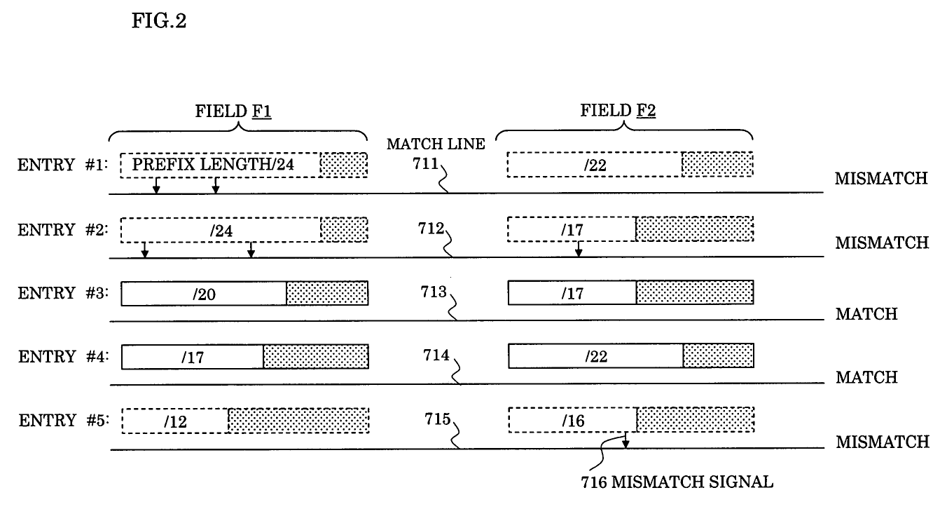

Firstly, states of the entries #1-#5 common to the above-mentioned embodiments (1) and (2) are shown in FIG. 2, which schematically show, in the same way as FIG. 1, a match/mismatch state for each of the entries #1-#5 stored in the database when a retrieval key (not shown) for a plurality of retrieved fields F1 and F2 is inputted.

In addition to FIG. 1, FIG. 2 shows match lines 711-715 respectively corresponding to the entries #1-#5. For the entries #1, #2, and #5, mismatch signals shown by arrows pointing downward (e.g. a mismatch signal 716 in the entry #5) are outputted for the match lines 711, 712, and 715, respectively.

Thus, while the entries #1, #2, and #5 having the mismatch signals outputted are “mismatch”, the entries #3 and #4 having no mismatch signal outputted are “match”, so that the interim retrieval result is obtained.

### Embodiment (1)

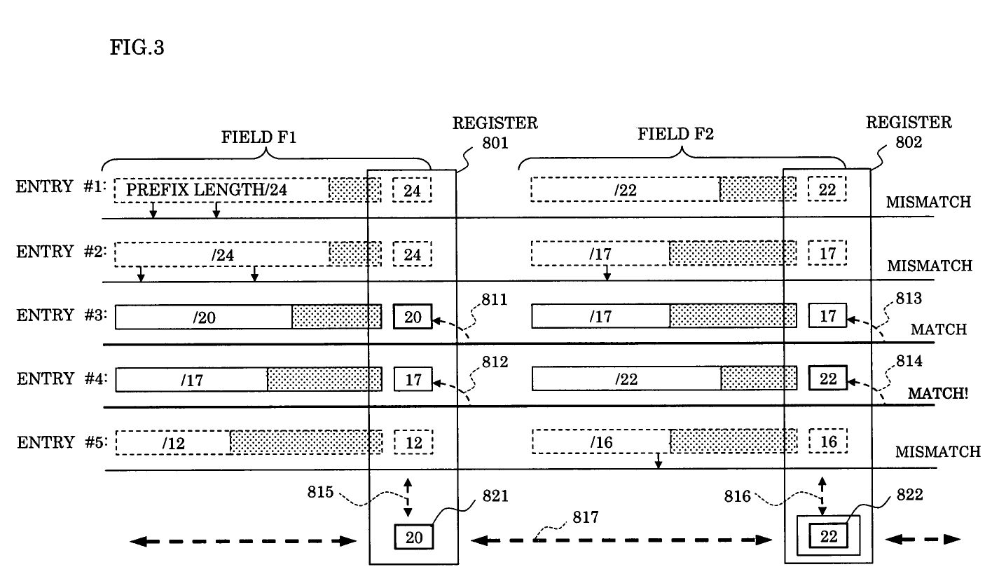

A method for obtaining the final retrieval result by mutually comparing the longest prefix lengths with one another for each of the retrieved fields regardless of the storing order of the entries #1-#5 in the states of FIG. 2 will now be described referring to FIG. 3.

As shown in FIG. 3, registers 801 and 802 are provided for holding prefix lengths for the fields F1 and F2 of the entries #1-#5. Namely, in the register 801, “24”, “24”, “20”, “17”, and “12” that are respective prefix lengths of the field F1 of the entries #1-#5 are saved. Likewise, in the register 802, “22”, “17”, “17”, “22”, and “16” that are respective prefix lengths of the field F2 of the entries #1-#5 are saved.

It is to be noted that while it is required to preset the value of the prefix length of each of the entries #1-#5 for the above-mentioned registers 801 and 802 before the retrieval operation, a network manager has only to input the prefix lengths at the time of an entry preparation. Alternatively, the CAM device itself may count the value set for the mask bit to be automatically inputted to the registers 801 and 802.

In FIG. 3, for the entries #3 and #4 obtained as the interim retrieval result, the registers 801 and 802 are respectively referred to as shown by dotted line arrows 811-814 so that for the field F1, the prefix length “20” of the entry #3 and the prefix length “17” of the entry #4 are obtained, while for the field F2, the prefix length “17” of the entry #3 and the prefix length “22” of the entry #4 are obtained.

For these prefix lengths, when maximum values 821 and 822 in the fields F1 and F2 as shown by dotted line arrows 815 and 816 are obtained, the maximum value 821 in the field F1 is the prefix length “20” of the entry #3 and the maximum value 822 in the field F2 is the prefix length “22” of the entry #4.

When the maximum value is obtained by comparing the maximum values 821 and 822 with each other as shown by a dotted line arrow 817, it is “22” that is the maximum value 822. Therefore, by prioritizing the field F2, the entry #4 whose prefix length is the longest in the field F2 assumes the final retrieval result of the CAM retrieval result.

### Embodiment (2)

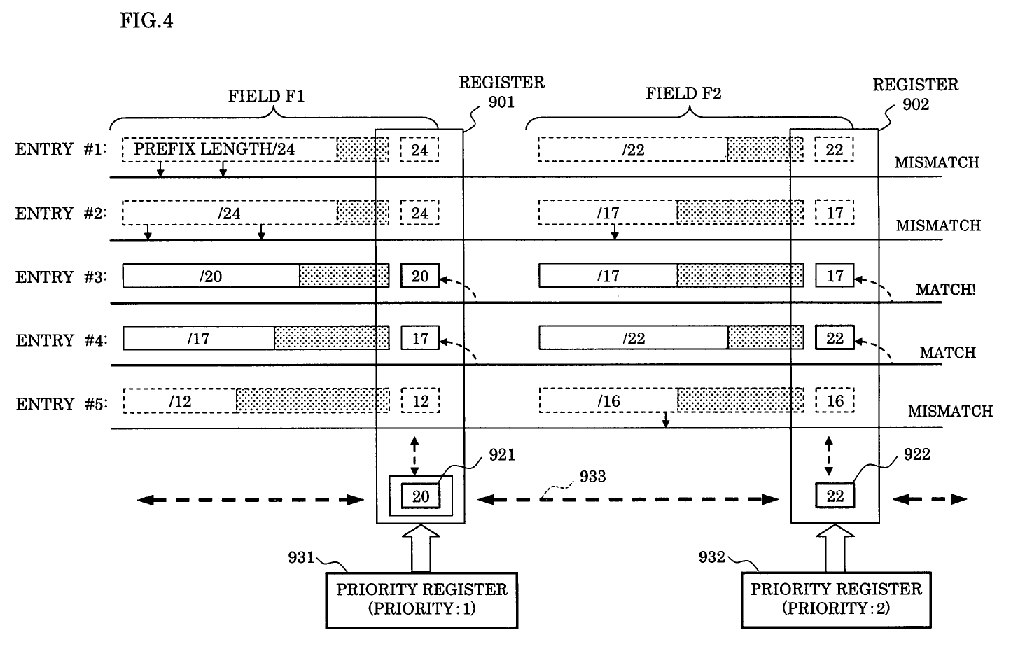

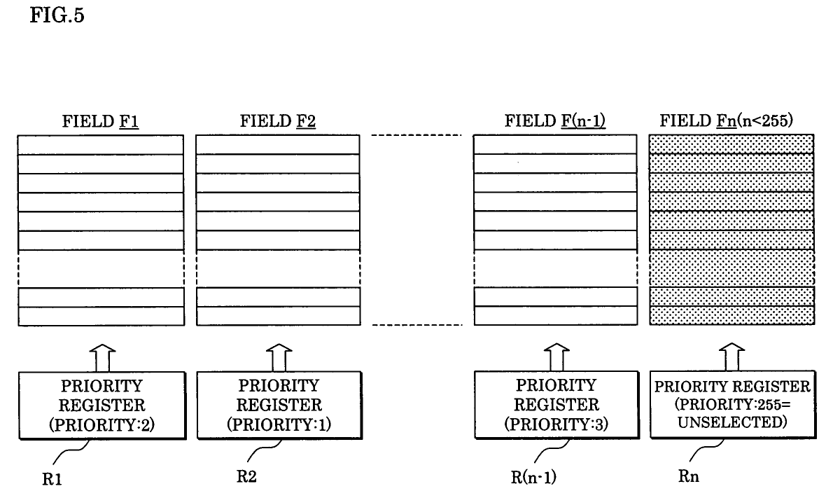

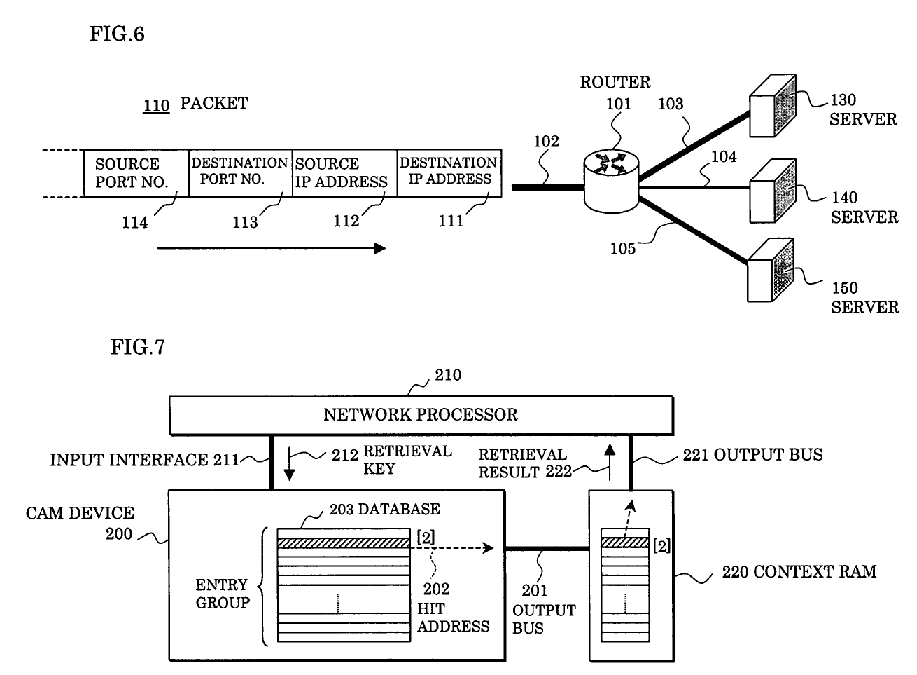

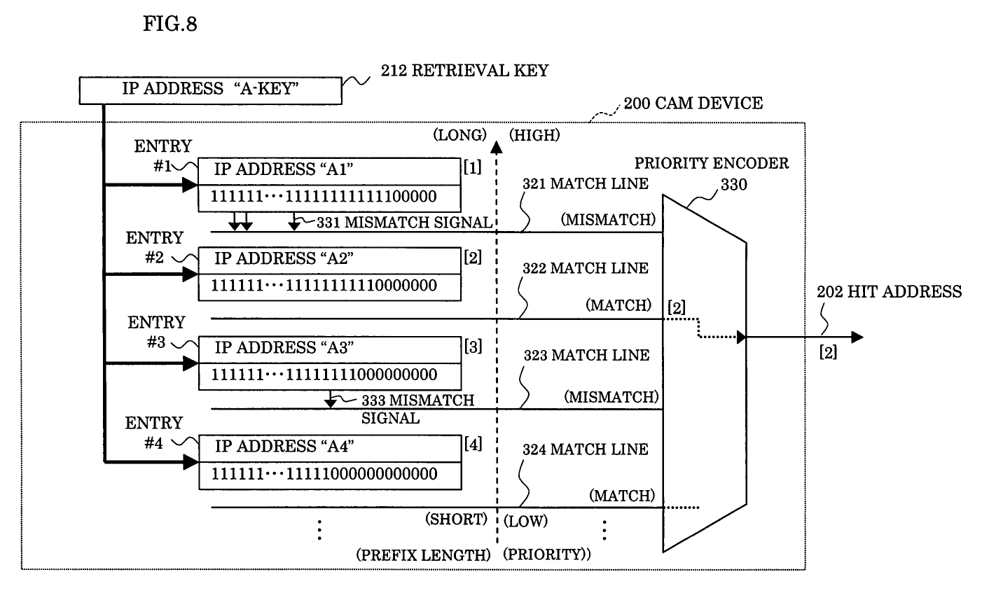

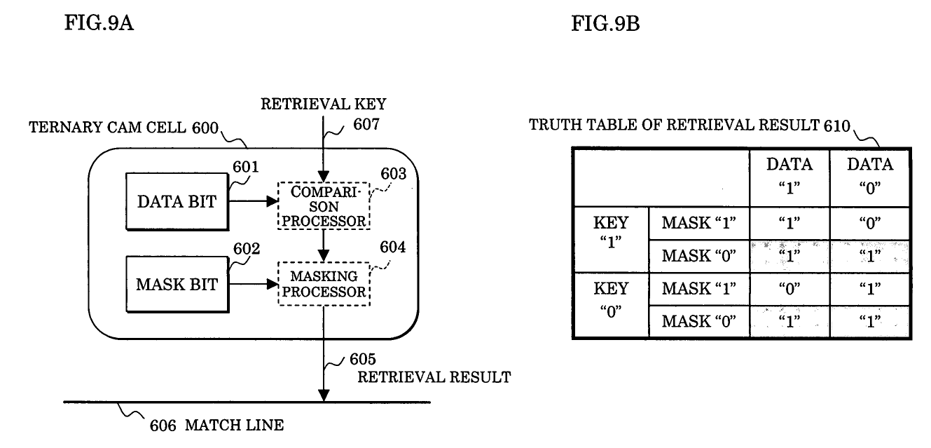

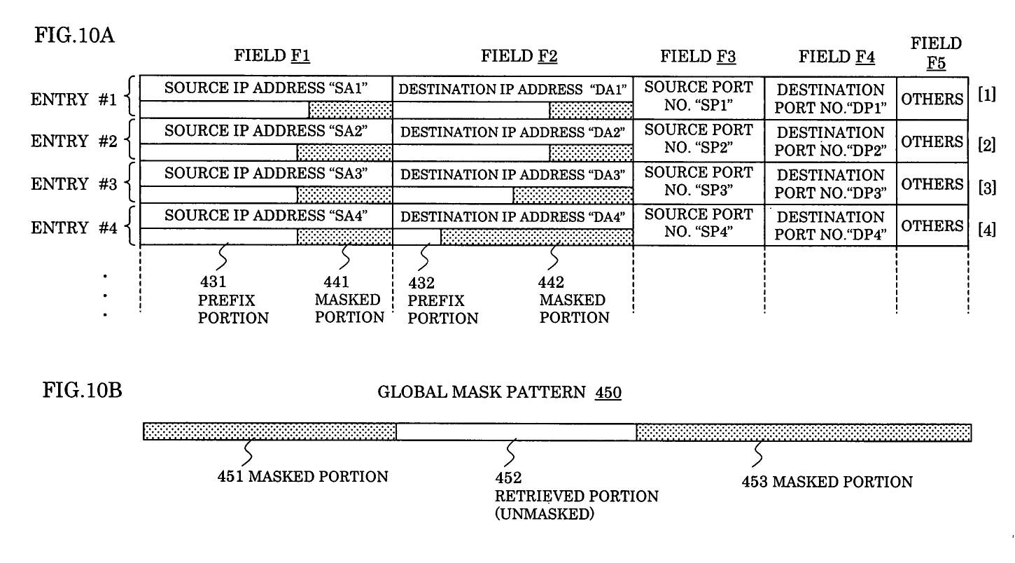

A method for obtaining a final retrieval result by presetting a priority for each of the fields regardless of the storing order of the entries #1-#5 in the states of FIG. 2 will now be described referring to FIG. 4.

Registers 901 and 902 shown in FIG. 4 correspond to the registers 801 and 802 shown in FIG. 3, and in the same way as in the embodiment (1), holds the prefix lengths for each of the fields F1 and F2 for the entries #1-#5.

Also, maximum values 921 and 922 in the register 901 and 902 are obtained in the same way as the maximum values 821 and 822 in the registers 801 and 802 shown in FIG. 3.

In FIG. 4, different from FIG. 3, priority registers 931 and 932 are respectively provided for the fields F1 and F2. It is to be noted that the values to be set in the priority registers 931 and 932 are made changeable every time the retrieval is made.

In the example of FIG. 4, a state is shown where “1” indicating the highest priority is set in the priority register 931 of the field F1 and “2” is set in the priority register 932 of the field F2.

In this case, the comparison of the priorities between the fields shown by a dotted line arrow 933 is performed based on the priority registers 931 and 932, so that the entry #3 assuming the longest prefix length in the field F1 of the higher priority assumes the final retrieval result.

FIG. 5 is a modification of the embodiment (2) showing a case where the priority register is used as a global mask pattern. For example, it is supposed that priority registers Ri-Rn corresponding to the fields F1-Fn, where n<255, are provided.

In this case, it is made possible to exclude the field Fn for which “255” that is the priority indicating “unselected” is set in the priority register Rn from the retrieved fields. It is to be noted that a value indicating “unselected” is required to be made larger than “n” since the field number is “n”.

As described above, in a data retrieval method and device according to the present invention, entries having all of unmasked bits in all of retrieved fields matched with data bits of retrieval keys corresponding to the unmasked bits are determined to be an interim retrieval result from among entries divided into a plurality of fields and stored in a database; a longest prefix length for each of the retrieved fields is obtained from among prefix lengths of the retrieved fields of the interim retrieval result; and an entry in the interim retrieval result having the longest prefix length in one of the retrieved fields whose priority is the highest is determined to be a retrieval result. Therefore, it is made possible to obtain a more appropriate retrieval result without being restricted by the storing order of the entries.

What is claimed is:

1. A data retrieval method comprising:
a first step of determining, from among entries divided into a plurality of fields and stored in a database, entries having all of unmasked bits in all of retrieved fields matched with data bits of retrieval keys corresponding to the unmasked bits to be an interim retrieval result;
a second step of obtaining a longest prefix length for each of the retrieved fields from among prefix lengths of the retrieved fields of the interim retrieval result; and
a third step of determining an entry in the interim retrieval result having the longest prefix length in one of the retrieved fields whose priority is the highest to be a retrieval result.

2. The data retrieval method as claimed in claim 1, wherein one of the retrieved fields whose priority is the highest comprises a longest retrieved field in the longest prefix lengths obtained at the second step.

3. The data retrieval method as claimed in claim 1, wherein a priority is set in each of the fields before retrieval is started.

4. The data retrieval method as claimed in claim 3, wherein the priority is changeable every time retrieval is made.

5. The data retrieval method as claimed in claim 3, wherein a field having a predetermined value set therein as the priority is excluded from the retrieved fields.

6. A data retrieval device comprising:
a database storing entries divided into a plurality of fields;
a prefix length holding portion holding a prefix length per field of the entries;
a computing portion determining entries having all of unmasked bits in all of retrieved fields matched with data bits of retrieval keys corresponding to the unmasked bits to be an interim retrieval result, obtaining a longest prefix length for each of the retrieved fields from among prefix lengths of the retrieved fields of the interim retrieval result, and determining an entry in the interim retrieval result having the longest prefix length in one of the retrieved fields whose priority is the highest to be a retrieval result.

7. The data retrieval device as claimed in claim 6, wherein one of the retrieved fields whose priority is the highest comprises a longest retrieved field in the longest prefix lengths obtained by the computing portion.

8. The data retrieval device as claimed in claim 6, wherein a priority is set in each of the fields before retrieval is started.

9. The data retrieval device as claimed in claim 8, wherein the priority is changeable every time retrieval is made.

10. The data retrieval device as claimed in claim 8, wherein a field having a predetermined value set therein as the priority is excluded from the retrieved fields.
